(19) United States
(12) Patent Application Publication
(10) Pub. No.: US 2018/0012024 A1
(43) Pub. Date: Jan. 11, 2018

(54) PROCESSOR STATE DETERMINATION

(71) Applicant: HEWLETT-PACKARD DEVELOPMENT COMPANY, L.P., HOUSTON, TX (US)

(72) Inventors: MAUGAN VILLATEL, BRITOL (GB); CHRIS DALTON, BRITOL (GB)

(21) Appl. No.: 15/539,825

(22) PCT Filed: Jan. 30, 2015
(86) PCT No.: PCT/US15/13757

§ 371 Date: Jun. 26, 2017

(51) Int. Cl. G06F 21/57; G06F 21/74; G06F 21/56

(52) U.S. Cl. CPC G06F 21/577; G06F 21/565; G06F 21/74

(57) ABSTRACT

An example system includes a main processor operable in a normal mode or a trusted mode, the main processor having an embedded diagnostic trusted code executable in the trusted mode; a secure memory accessible by the main processor when the main processor is in the trusted mode and inaccessible to the main processor when the main processor is in the normal mode, wherein execution of the embedded diagnostic trusted code causes the main processor to write diagnostic information to the secure memory; and a monitor processor having access to the secure memory to analyze the diagnostic information to determine a state of the main processor.

### BACKGROUND

Computer systems are vulnerable to ever-increasingly sophisticated attacks from hacking, viruses, Trojan horses and other malicious software. Such attacks can cause significant damage to the computer systems, as well as resulting in loss or theft of critical data. Some attacks may cause a system processor to, for example, make secure information available to an untrusted entity.

### BRIEF DESCRIPTION OF THE DRAWINGS

For a more complete understanding of various examples, reference is now made to the following descriptions taken in connection with the accompanying drawings in which:

FIG. 1 is a schematic illustration of an example system;

FIG. 2 is a flowchart illustrating an example method for configuring the example system of FIG. 1; and

FIG. 3 is a flowchart illustrating an example method for determining a processor state.

### DETAILED DESCRIPTION

Various examples described below provide systems and methods which provide for the monitoring of a processor of a system in a secure and tested manner. A monitoring processor separate from the main processor, which may be the target of a malicious attack, causes execution of a trusted diagnostic code while the main processor is in a trusted mode. In various examples, the monitoring processor can trigger an interrupt that switches the main processor from a normal mode to a trusted mode for execution of the trusted diagnostic code. The trusted diagnostic code generates results which are stored in a secure memory which is accessible to the main processor only when the main processor is in a trusted mode. The secure memory is made inaccessible to the main processor when the main processor is operating in a normal mode. The monitoring processor may then access the results from the secure memory and perform an analysis to determine whether the main processor is operating in a normal intended manner or whether it has been corrupted.

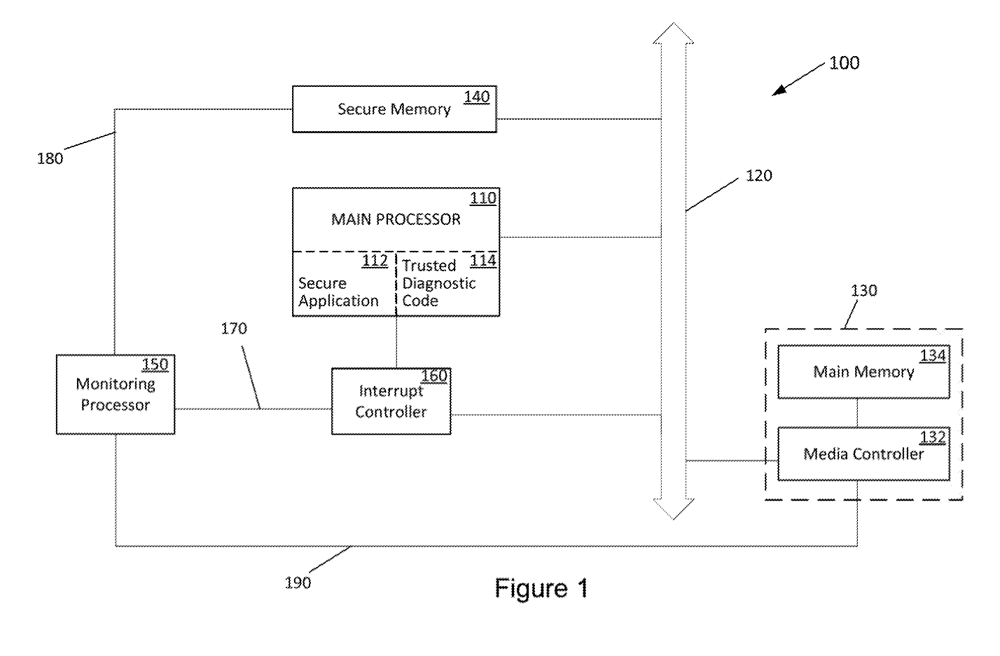

Referring now to FIG. 1, an example system 100 is schematically illustrated. The example system 100 may be implemented in any manner desired, such as a server for a variety of purposes. For example, the example system 100 may be an enterprise server to allow access to data for a number of users. In other examples, the example system 100 may be a server for consumers of a software service. Various other uses are possible and are contemplated within the scope of the present disclosure.

The example system 100 includes a main processor 110, or a central processing unit (CPU). In various examples, the main processor 110 controls various operations of the example system 100 and executes instructions, such as program code. The main processor 110 may be a part of the examples system 100, which may be a server, and can execute instructions based on requests from client devices. Such instructions may include running particular program code or accessing particular data, for example.

The main processor 110 of the example system 100 may communicate with other components of the example system 100 through a main communication bus 120. For example, the main communication bus 120 may allow the main processor 110 to access a primary storage system 130 of the example system 100. The primary storage system 130 may be used by the example system 100 to store a variety of information such as data for access by users, programs to be loaded and executed by the main processor, data or files needed for operation of the example system 100 and/or the main processor 110, etc.

In the illustrated example of FIG. 1, the primary storage system 130 of the example system 100 includes a media controller 132 and a main memory 134. The media controller 132 may receive commands from various sources, such as the main processor 110 (via the main communication bus 120) for access to the main memory 134. Such commands may include access to a particular address for a read or a write, for example.

In various examples, the main processor 110 may support operation secure mode. Such operation may be desirable when executing instructions of a sensitive nature. For example, the example system 110 may be a server that supports a financial institution, and the main processor 110 may execute instructions related to a banking application. Accordingly, in various examples, the main processor 110 may be operable in either a normal mode or a trusted mode (e.g., a secure mode).

The main processor 110 of the example system 100 may be provided with a variety of applications that are embedded within the main processor 110. In particular, as illustrated in the example of FIG. 1, main processor 110 may be provided with one or more secure applications 112, such as a bank application or the like. Those skilled in the art will appreciate that numerous other types of applications, secure or non-secure, may be embedded in the main processor 110. Of course, in other examples, the applications may be stored in the main memory 134, including instructions that may be executed by the main processor 110.

As noted above, systems such as the example system 100 of FIG. 1 may become susceptible to malicious attacks which may corrupt the main processor 110 of the example system 100. In this regard, various examples of the present disclosure provide for the detection of such corruption of the main processor 110. As illustrated in FIG. 1, the example system 100 is provided with a monitoring processor 150 for identifying such corruption by, for example, determining a state of the main processor 110. In the example system 100 of FIG. 1, the monitoring processor 150 is physically separate from the main processor 110. In other examples, the functionality of the monitoring processor 150 may be implemented as a secure or partitioned code within the main processor 110.

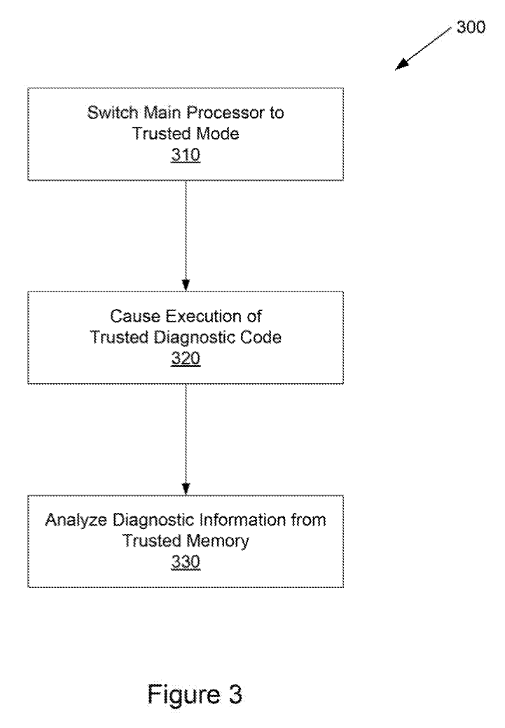

In various examples, the monitoring processor 150 may cause execution of a trusted diagnostic code by the main processor 110. As illustrated in the example of FIG. 1, the example system 100 may provide that a trusted diagnostic code 114 is embedded in the main processor 110. Examples of the trusted diagnostic code 114 provided below with reference to FIG. 3.

In various examples, access to the main processor 110 by the monitoring processor 150 may be through in interrupt controller 160 of the main processor 110. In this regard, monitoring processor 150 may issue an interrupt to the interrupt controller 160 through a dedicated monitoring interrupt line 170 between the monitoring processor 150 and the interrupt controller 160. In the example system 100 of FIG. 1, the monitoring processor 150 is shown as being a physical separate from the main processor 110, with an interrupt sent through the dedicated monitoring interrupt line 170. In other examples, the monitoring processor 150 may be a logically separated portion of the main processor 110. In such cases, the monitoring processor 150 may issue a software-generated interrupt to the main processor.

In addition to the main memory 134 of the primary storage system 130, the example system 100 is further provided with a secure memory 140. Secure memory 140 is accessible by the main processor 110 through the main communication bus 120. Further, the secure memory 140 may be accessible by the monitoring processor 150 through a dedicated secure memory access bus 180. In the example system 100 of FIG. 1, the secure memory 140 is physically separated from the main memory 134 of the primary storage system 130. In other examples, the secure memory 140 and the main memory 134 may be implemented as partitioned portions of a common memory system.

As described in greater detail below, in monitoring the status of the main processor 110, the monitoring processor 150 may further access the primary storage system 130. In various examples, in order to facilitate secure access of the primary storage system 130, a dedicated monitoring memory bus 190 may be provided between the monitoring processor 150 and the media controller 132 of the primary storage system 130. The media controller 132 may provide arbitration for access to the main memory 130 based on requests received through the dedicated monitoring memory bus 190 or the main communication bus 120.

In various examples, the monitoring processor 150 may cause execution of the trusted diagnostic code 114 embedded in the main processor 110 to determine the state of the main processor. In this regard, execution of the trusted diagnostic code 114, along with an analysis of results of the execution of the trusted diagnostic code 114, may reveal, for example, whether the main processor 110 has been corrupted by a malicious attack. As described in the examples herein, the example system 100 may be configured to allow the monitoring processor 150 the cause execution of the trusted diagnostic code 114 at the desired times or intervals. In various examples, the example system 100 may be configured, for example, at start up or reboot to allow the monitoring processor 150 to cause the desired execution of the trusted diagnostic code 114.

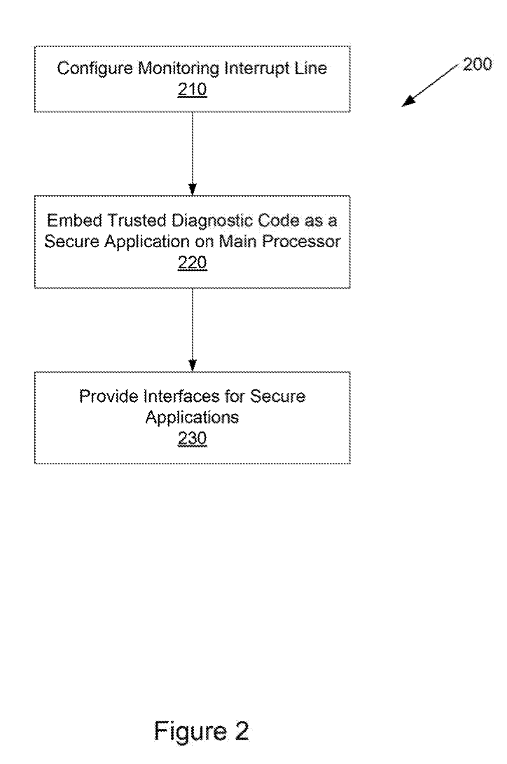

Referring now to FIG. 2, an example method is illustrated for configuring the example system of FIG. 1 to facilitate monitoring or determination of the status of the main processor 110 through execution of the trusted diagnostic code 114, for example. The example method 200 begins at start up or reboot of the example system 100 with configuring of the dedicated monitoring interrupt line 170 (block 210). In this regard, the dedicated monitoring interrupt line 170 may be configured such that an interrupt trigger issued by the monitoring processor 150 causes the main processor to transition from a normal mode of operation to a trusted mode, or secure mode. In various example, operation of the main processor in secure mode may alter operation of the main processor in a variety of manners. For example, certain resources within the main processor may be available only when the main processor 110 is operating in a secure mode, or the main processor 110 or certain components associated with the main processor 110 may be inaccessible to un-trusted clients while the mean processor 110 is operating in a secure mode.

In the example method 200, the interrupt controller 160 may be configured to install an interrupt from the monitoring processor 150. In this regard, various examples, the interrupt controller 160 may be configured to cause execution of a desired code when the interrupt from the monitoring processor 150 is received. As described in the examples below and as noted above with reference to FIG. 1, the executed code may be embedded in the main processor 110.

At block 220, the example method 200 continues the startup or reboot process with embedding of the trusted diagnostic code 114 in the main processor 110. In various examples, the trusted diagnostic code 114 is embedded as a secure application, thus preventing corruption of the trusted diagnostic code 114 by an un-trusted client or code.

In various examples, the example method 200 may provide interfaces that may be needed for operation of various secure applications, such as secure application 112 of FIG. 1 (block 230). For example, certain interfaces may require installation or configuring to allow various clients access such secure applications 112 as a banking application, for example. Thus, the main processor 110 may be configured to be accessible in the trusted mode for execution of various secure applications not just by the monitoring processor 150, but also by trusted clients. In various examples, the trusted diagnostic code 114 may be one particular secure application which is accessible only by the monitoring processor 150 through the interrupt controller 160.

Referring now to FIG. 3, an example method for determining the state of the main processor 110 of the example system 100 is illustrated. In accordance with the example method 300, the main processor 110 is switched from a normal mode to a trusted mode (block 310). In various examples, as described above, the switching of the main processor 110 to the trusted mode may be initiated by the monitoring processor 150. The monitoring processor 150 may schedule checks of the main processor 110 at, for example, regular intervals or based on other factors. In various examples, monitoring processor 150 may cause the main processor 110 to switch from the normal mode to the trusted mode by issuing in interrupt through the dedicated monitoring interrupt line 172 the interrupt controller 160 of the example system 100 of FIG. 1.

With the main processor 110 in the trusted mode, a trusted diagnostic code, such as the embedded trusted diagnostic code 114 of FIG. 1, may be executed by the main processor 110 (block 320). As noted above, execution of the embedded trusted diagnostic code 114 may be caused by the monitoring processor 150. For example, the interrupt issued by the monitoring processor 152 the interrupt controller 160 may cause both the switching of the main processor to the trusted mode and the execution of the trusted diagnostic code 114.

As noted above, the trusted diagnostic code 114 may take several forms and may determine whether the main processor 110 is operating as intended or has been corrupted. In one example, the trusted diagnostic code 114 facilitates analysis of configuration registers in the operating system layer. In this regard, one example of the trusted diagnostic code 114 is provided below for execution for a main processor 110 having an ARMv8-A architecture. Those skilled in the art are familiar with processors having the ARM architecture, and a detailed discussion of such processors is not relevant to the present disclosure.

In the case of a main processor 110 having an ARMv8-A architecture, the example trusted diagnostic code may execute in a monitor mode, also referred to as exception level 3 (EL3). Thus, operating at EL3, the trusted diagnostic code 114 may read configuration registers of the OS layer, also referred to as exception level 1 (EL1). In various examples, the configuration registers read by the trusted diagnostic code 114 may include ttbr0_el1, ttbr1_el1, tcr_el1. Of course, in other examples, other registers indicative of the status of the main processor 110 may be read.

While the example trusted diagnostic code 114 described above is applicable to a main processor 110 having an ARM architecture, the present disclosure is not limited neither to the particular example trusted diagnostic code nor to main processors 110 having an ARM architecture. Those skilled in the art will appreciate that other examples of trusted diagnostic codes 114 may be designed for execution on various other types of processors, and such other examples are contemplated within the scope of the present disclosure.

The results from execution of the trusted diagnostic code 114 are stored in the secure memory 140. In various examples, access to the secure memory 140 is provided to the main processor 110 or, more particularly, the trusted diagnostic code 114 only when the main processor 110 is operating in a trusted mode. Thus, results of execution of the trusted diagnostic code 114 are secure from tampering or corruption by an un-trusted entity or code, such as a malicious attack. In various examples, the trusted diagnostic code 114 may store the results of the execution (e.g., values of the configuration registers) in a wall defined location within the secure memory 140. For example, a predetermined address may be used to store the information.

Upon completion of the execution of the trusted diagnostic code 114, the main processor may return to operation in the normal mode. The monitoring processor 150 may then analyze diagnostic information, such as the information stored in the secure memory 140 by the trusted diagnostic code 114 (block 330). In this regard, monitoring processor 150 may access the secure memory 140 to obtain the values of the configuration registers from the previously noted wall defined place in the secure memory 140.

In various examples, the secure memory 140 is a non-transitory storage medium which is accessed through trusted communication paths. In various examples, the trusted communication for access to the secure memory 140 may be enabled with software or hardware. In one example, the communication path to the secure memory 140 may be trusted due to authentication using cryptography or other software security measures. In other examples, the access is limited to the secure memory 140 through hardware, such as hardware which provides access control through authentication. In other examples, the hardware maybe a dedicated bus with limited accessibility. For example, in the example system of FIG. 1, the secure memory 140 may be accessed by the monitoring processor 150, which is a trusted entity, through the dedicated secure memory access bus 180. Further, the secure memory 140 may be accessed by the main processor 110 through the main communication bus 120 only when the main processor 110 is operating in a trusted mode. In this regard, the main communication bus 120 may also carry information indicative of the state of the main processor (e.g., normal mode or trusted mode). Thus, when the results of the trusted diagnostic code 114 are written to the secure memory, the results may include a flag to indicate that the results were written while the main processor 110 was operating in a trusted mode.

In the example system of FIG. 1, the main processor 110 accesses the secure memory 140 through the main communication bus 120. In other examples, a dedicated bus may be provided between the main processor 110 and the secure memory 140. The dedicated bus may be accessible only when the main processor 110 is operating in a trusted mode, thus providing access to the secure memory 140 only when the main processor 110 is in the trusted mode.

In various examples, monitoring processor 150 may compare the information from the secure memory 140 with predefined information to determine whether the main processor 110 is operating in a normal and intended manner. In certain examples, the monitoring processor may also obtain information from the primary storage system 130 in performing its analysis.

Upon performing its analysis, the monitoring processor 150 may determine that the main processor 110 is operating properly. Based on this determination, the monitoring processor 150 may take no action and await the next execution of the trusted diagnostic code 114. If, on the other hand, the monitoring processor 150 determines that the main processor 110 is not operating properly or as intended, it may conclude that the main processor has been corrupted or otherwise compromised. In this case, the monitoring processor 150 may take any of a variety of actions two, for example, alert and administrator or to cause the main processor 110 pause or shut down.

The examples described above, the trusted diagnostic code 114 is executed based on an interrupt from the monitoring processor 150 which switches operation of the main processor 110 from a normal mode to a trusted mode. In other examples, the trusted diagnostic code 114 may be executed each times the main processor 110 is switched to a trusted mode. For example, the main processor 110 may switch to a trusted mode based on a request from a trusted client for a secure application, such as the secure application 12 illustrated in FIG. 1. In this regard, the request from the trusted client for a secure application 112 may cause the main processor 110 to begin operating in the trusted mode. The trusted diagnostic code 114 may be designed to launch each time the main processor 110 switches to the trusted mode, regardless of the reason for the switch. In various examples, this may provide for increased monitoring of the functioning of the main processor 110.

Thus, various examples provide for the secure monitoring of the main processor. The monitoring processor can cause execution of the trusted diagnostic code while the main processor is in a trusted mode. The results are stored in the secure memory which is accessible to the main processor only when the main processor is in a trusted mode and cannot be corrupted by an un-trusted source. The monitoring processor can then access the results from the secure memory and can detect if the main processor has been corrupted.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. which may be designed to perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

The various examples set forth herein are described in terms of example block diagrams, flow charts and other illustrations. Those skilled in the art will appreciate that the illustrated examples and their various alternatives can be implemented without confinement to the illustrated examples. For example, block diagrams and their accompanying description should not be construed as mandating a particular architecture or configuration.

What is claimed is:

1. A system, comprising:
a main processor operable in a normal mode or a trusted mode, the main processor having an embedded diagnostic trusted code executable in the trusted mode;
a secure memory accessible by the main processor when the main processor is in the trusted mode and inaccessible to the main processor when the main processor is in the normal mode, wherein execution of the embedded diagnostic trusted code causes the main processor to write diagnostic information to the secure memory; and
a monitor processor having access to the secure memory to analyze the diagnostic information to determine a state of the main processor.

2. The system of claim 1, wherein the monitor processor causes switching of the main processor from the normal mode to the trusted mode by issuing an interrupt through an interrupt line between the monitor processor and an interrupt controller of the main processor.

3. The system of claim 1, wherein the monitor processor switches the main processor from the trusted mode to the normal mode after the diagnostic information is written to the secure memory.

4. The system of claim 1, wherein monitor processor analyzes the diagnostic information by accessing a main memory system of the main processor and analyzing information on the main memory system and the diagnostic information written to the secure memory.

5. The system of claim 4, wherein the main memory system is accessed by the monitor processor through a dedicated monitor bus between the monitor processor and the main memory system of the main processor.

6. A method, comprising:
switching a main processor from a normal mode to a trusted mode;
causing execution of a trusted code on the main processor, wherein execution of the trusted code causes writing of diagnostic information to a trusted memory, the trusted memory being accessible to the main processor only during trusted mode; and
analyzing, by a monitor processor, the diagnostic information to determine a state of the main processor.

7. The method of claim 6, further comprising:
switching the main processor from the trusted mode to the normal mode after writing of diagnostic information to the trusted memory, wherein the trusted memory is inaccessible to the main processor during the normal mode.

8. The method of claim 6, wherein the switching of the main processor from the normal mode to the trusted mode is initiated by the monitor processor.

9. The method of claim 6, wherein the switching the main processor from the normal mode to the trusted mode is initiated by a request from a trusted client for a secure application.

10. The method of claim 6, wherein analyzing the diagnostic information includes:
accessing, by the monitor processor, a main memory system of the main processor; and
determining a state of the main processor by analyzing information on the main memory system and the diagnostic information to determine a state of the main processor.

11. The method of claim 10, wherein the main memory system is accessed by the monitor processor through a dedicated monitor bus between the monitor processor and the main memory system of the main processor.

12. The method of claim 11, wherein the memory system includes a memory controller and a memory, the monitor bus allowing access to the memory by the monitor processor through the memory controller.

13. A computer program product, embodied on a non-transitory computer-readable medium, comprising:
computer code for switching a main processor from a normal mode to a trusted mode;
computer code for causing execution of a trusted code on the main processor, wherein execution of the trusted code causes writing of diagnostic information to a trusted memory, the trusted memory being accessible to the main processor only during trusted mode; and
computer code for analyzing the diagnostic information to determine a state of the main processor.

14. The computer program product of claim 13, further comprising:
computer code for switching the main processor from the trusted mode to the normal mode after writing of diagnostic information to the trusted memory, wherein the trusted memory is inaccessible to the main processor during the normal mode.

15. The computer program product of claim 13, wherein the computer code for analyzing the diagnostic information includes:
computer code for accessing a main memory system of the main processor; and
computer code for determining a state of the main processor by analyzing information on the main memory system and the diagnostic information to determine a state of the main processor.
